(19) United States
(12) Patent Application Publication
(10) Pub. No.: US 2010/0208609 A1
(43) Pub. Date: Aug. 19, 2010

(54) DYNAMIC MAPPING OF QUALITY OF SERVICE TRAFFIC

(75) Inventors: Chandrasekhar T. Sundarraman, San Diego, CA (US); Jun Wang, La Jolla, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/704,461

(22) Filed: Feb. 11, 2010

Related U.S. Application Data
(60) Provisional application No. 61/152,593, filed on Feb. 13, 2009.

(51) Int. Cl. H04L 12/26

(52) U.S. Cl. 370/252

(57) ABSTRACT

Providing for dynamic mapping of quality of service (QoS) for wireless communication services provided at least in part over broadband Internet is described herein. By way of example, a data packet can be received and analyzed at a broadband Internet link to obtain a QoS level for the data packet. The QoS level can be correlated with a QoS of reverse link traffic for the communication service. If an inconsistency exists, the QoS level can be updated to be consistent with the QoS of the reverse link traffic. In at least one aspect, updating the QoS level can be conditioned at least in part on a type of traffic or service employed for the communication service. In this manner, traffic transmitted over the broadband Internet link can be treated with an appropriate QoS even if marked incorrectly by an entity transmitting the data packet.

### CLAIM OF PRIORITY UNDER 35 U.S.C §119

The present application for patent claims priority to Provisional Patent Application Ser. No. 61/152,593 entitled “METHOD AND APPARATUS TO ENABLE DYNAMIC MAPPING OF QUALITY OF SERVICE TRAFFIC” and filed Feb. 13, 2009, assigned to the assignee hereof and hereby expressly incorporated by reference herein.

### BACKGROUND

I. Field

The following description relates generally to wireless communications, and more particularly to facilitating arbitration of quality of service association for wireless streams employing user deployed, broadband-based wireless access points.

II. Background

Wireless communication systems are widely deployed to provide various types of communication content, such as voice content, data content, and so on. Typical wireless communication systems can be multiple-access systems capable of supporting communication with multiple users by sharing available system resources (e.g., bandwidth, transmit power, . . . ). Examples of such multiple-access systems can include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), or multi-carrier wireless specifications such as evolution data optimized (EV-DO), one or more revisions thereof, etc.

Generally, wireless multiple-access communication systems can simultaneously support communication for multiple mobile devices. Each mobile device can communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations can be established via single-input single-output (SISO) systems, multiple-input single-output (MISO) systems, multiple-input multiple-output (MIMO) systems, and so forth.

In recent years, users have started to replace fixed line communications with mobile communications and have increasingly demanded great voice quality, reliable service, and low prices. One problem associated with high quality mobile communications is the need to improve best-effort traffic in multiple access systems. Although multiple access enables increased network loading, it can also result in increased interference, degrading wireless communications. Accordingly, improved interference mitigation has been an increased priority for wireless system designers in recent years. One common mechanism for interference mitigation is planned deployment, where large macro base stations are positioned a sufficient distance from other such base stations as to cause minimal inter-cell interference. Other techniques for mitigating interference in a planned deployment include beamshaping, transmit power management, and the like.

Complications to conventional planned deployment have also arisen. A new class of small base stations has emerged, which may be installed in a user's home and provide indoor wireless coverage to mobile units using existing broadband Internet connections. Such personal miniature base stations are generally known as access point base stations, or, alternatively, Home Node B (HNB), Femto access points, or Femto cells. Typically, such miniature base stations are connected to the Internet and the mobile operator's network via DSL router or cable modem.

Because these personal base stations are deployed by individual system users, rather than a network provider, location of these base stations is unplanned, and can frustrate interference mitigation mechanisms based on planned deployment. For instance, a high power macro base station can cause significant interference to relatively small power Femto access point base stations within wireless range of the macro base station. On the other hand, because Femto access point base stations typically employ restricted association, allowing network access to only a select set of terminals. Un-associated terminals are required to obtain service from the macro network instead. Where an un-associated terminal is very close to the Femto access point base station, however, even low power transmission from the Femto access point base station can cause significant interference for the macro network. As more and more access point base stations are installed in unplanned locations, this problem becomes more widespread. Accordingly, additional mechanisms for managing wireless communications in these semi-planned or un-planned environments (also known as heterogeneous wireless networks or heterogeneous wireless environments) are being developed to mitigate this problem.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects of the subject disclosure in a simplified form as a prelude to the more detailed description that is presented later.

The subject disclosure provides for dynamic mapping of quality of service (QoS) for communication services provided to a mobile device. According to particular aspects, a data packet transmitted as part of a communication service can be analyzed to obtain a QoS level for the data packet. Further, the QoS level can be correlated with a QoS of reverse link traffic for the communication service. If an inconsistency exists, the QoS level can be updated to be consistent with the QoS of the reverse link traffic. In at least one aspect, updating the QoS level can be conditioned at least in part on a type of traffic or service employed for the communication service. In other aspects, the dynamic mapping can be applied at a gateway to a broadband Internet link, utilized to communicatively couple a wireless access point and an Internet Protocol network gateway (an IP network gateway). In this manner, traffic transmitted over the broadband Internet link can be treated with an elevated QoS if reverse link traffic is also treated with the elevated QoS. In at least one aspect of the subject disclosure, a first gateway to the broadband Internet link can perform traffic analysis to determine a type of traffic, and set a QoS level based on the type of traffic. A second gateway to the broadband Internet link can analyze traffic transmitted by the first gateway and set associated data packets transmitted in an opposite direction to the QoS level set by the first gateway.

In particular aspects of the subject disclosure, provided is a method for wireless communication. The method can comprise employing a communication interface to obtain a data packet that is part of a wireless communication involving a mobile device. Moreover, the method can comprise employing a processor to analyze the data packet to determine a QoS level established for the data packet. In addition to the foregoing, the method can comprise employing the processor to mark the data packet with a different QoS level if the QoS level established for the data packet is incorrect.

In other aspects, disclosed is an apparatus for wireless communication. The apparatus can comprise a communication interface that electronically communicates with a broadband link and with a wireless link, wherein the communication interface obtains downlink traffic (DL traffic) from the broadband link and obtains uplink traffic (UL traffic) from the wireless link. Further, the apparatus can comprise memory for storing instructions configured to establish QoS policies for the DL traffic or the UL traffic. Additionally, the apparatus can comprise a data processor for executing modules that implement the instructions. Particularly, the modules can include an analysis module that identifies a set of UL traffic and a set of DL traffic pertaining to a communication stream and an inspection module that identifies a QoS level associated with a data packet of the communication stream. In at least one aspect, the modules can also include a marking module that updates the QoS level if the QoS level is inconsistent with a reverse direction QoS level of a reverse direction data packet of the communication stream routed in an opposite direction as the data packet.

Further to the above, provided is an apparatus for wireless communication. The apparatus can comprise means for employing a communication interface to obtain a data packet from a mobile device over a wireless link. Additionally, the apparatus can comprise means for employing a processor to analyze the data packet to determine a QoS level established for the data packet. Further, the apparatus can comprise means for employing the processor to mark the data packet with a reverse link QoS level of a reverse link data packet if the QoS level established for the data packet is different from the reverse link QoS level.

In yet other aspects, disclosed is at least one processor configured for wireless communication. The processor(s) can comprise a module that obtains a data packet from a mobile device over a wireless link and a module that analyzes the data packet to determine a QoS level established for the data packet. Moreover, the processor(s) can comprise a module that marks the data packet with a reverse link QoS level of a reverse link data packet if the QoS level established for the data packet is different from the reverse link QoS level.

Furthermore, disclosed is a computer program product comprising a computer-readable medium. The computer-readable medium can comprise code for causing a computer to obtain a data packet from a mobile device over a wireless link and code for causing the computer to analyze the data packet to determine a QoS level established for the data packet. Additionally, the computer-readable medium can comprise code for causing the computer to mark the data packet with a reverse link QoS level of a reverse link data packet if the QoS level established for the data packet is different from the reverse link QoS level.

In one or more other aspects of the subject disclosure, a method of wireless communication is provided. The method can comprise employing a communication interface for electronic communication with a Femto access point (a FAP) over a broadband link and with an Internet Protocol gateway (an IP gateway) of an IP network. Moreover, the method can comprise employing a data processor to analyze a QoS level of a data packet of a communication stream received at the communication interface. Furthermore, the method can comprise employing the data processor to update the QoS level if the QoS level is inconsistent with reverse link traffic of the communication stream.

In still other aspects of the subject disclosure, provided is an apparatus for wireless communication. The apparatus can comprise a communication interface that communicatively couples the apparatus to an IP gateway via an IP link, and to a FAP via a broadband Internet link. Moreover, the apparatus can comprise memory for storing instructions configured to establish appropriate QoS for a data packet of a communication stream and a data processor for executing modules that implement the instructions. Further, the modules can comprise an analysis module that determines a current QoS specified for the data packet and an arbitration module that modifies the current QoS if a reverse direction QoS specified in a data packet of the communication stream that is routed in an opposite direction as the data packet is different from the current QoS.

In yet another aspect disclosed is an apparatus for wireless communication. The apparatus can comprise means for employing a communication interface for electronic communication with a FAP over a broadband link and with an IP gateway of an IP network. In addition, the apparatus can comprise means for employing a data processor to analyze a QoS level of a data packet of a communication stream received at the communication interface. Moreover, the apparatus can comprise means for employing the data processor to update the QoS level if the QoS level is inconsistent with reverse link traffic of the communication stream.

In one or more additional aspects of the subject disclosure, at least one data processor configured for wireless communication is provided. The processor(s) can comprise a module for electronic communication with a FAP over a broadband link and with an IP gateway over an IP network link. Furthermore, the processor(s) can comprise a module that analyzes a QoS level of a data packet of a communication stream received from the FAP or the IP gateway. It should also be understood that the processor(s) can further comprise a module that updates the QoS level if the QoS level is inconsistent with reverse link traffic of the communication stream.

In still other aspects, the subject disclosure provides a computer program product comprising a computer-readable medium. The computer-program product can comprise code for causing a computer for electronic communication with a FAP over a broadband link and with an IP gateway over an IP network link. Additionally, the computer-program product can comprise code for causing the computer to analyze a QoS level of a data packet of a communication stream received from the FAP or the IP gateway. In at least one particular aspect, the computer-program product can comprise code for causing the computer to update the QoS level if the QoS level is inconsistent with reverse link traffic of the communication stream.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates a block diagram of an example system for dynamic mapping of quality of service (QoS) for wireless communication.

FIG. 2 depicts a block diagram of an example communication environment for home Node B wireless communication.

FIG. 3 illustrates a block diagram of an example broadband communication for providing wireless services according to disclosed aspects.

FIG. 4 illustrates a block diagram of an example system comprising a Femto access point according to further aspects of the subject disclosure.

FIG. 5 depicts a block diagram of a sample system comprising a Femto gateway according to still other aspects of the subject disclosure.

FIG. 6 illustrates a flowchart of an example methodology for providing dynamic mapping of QoS for wireless communication according to further aspects.

FIG. 7 depicts a flowchart of a sample methodology for providing QoS in broadband-based wireless services according to other aspects.

FIG. 8 illustrates a flowchart of an example methodology for providing dynamic mapping of QoS according to at least one other disclosed aspect.

FIG. 9 depicts a flowchart of a sample methodology for providing QoS mapping for forward link traffic based on QoS of reverse link traffic.

FIG. 10 illustrates a block diagram of an example system that provides dynamic mapping of QoS for wireless communication.

FIG. 11 depicts a block diagram of a sample system that facilitates dynamic mapping of QoS for broadband-based wireless communication services.

FIG. 12 depicts a block diagram of a sample wireless communications apparatus employed in implementing various aspects of the subject disclosure.

FIG. 13 illustrates a block diagram of an example cellular environment for wireless communications according to further aspects.

FIG. 14 illustrates a block diagram of a sample communication system to enable deployment of access point base stations within a network environment.

### DETAILED DESCRIPTION

Various aspects are now described with reference to the drawings, wherein like reference numerals are used to refer to like elements throughout. In the following description, for purposes of explanation, numerous specific details are set forth in order to provide a thorough understanding of one or more aspects. It can be evident, however, that such aspect(s) can be practiced without these specific details. In other instances, well-known structures and devices are shown in block diagram form in order to facilitate describing one or more aspects.

In addition, various aspects of the disclosure are described below. It should be apparent that the teaching herein can be embodied in a wide variety of forms and that any specific structure and/or function disclosed herein is merely representative. Based on the teachings herein one skilled in the art should appreciate that an aspect disclosed herein can be implemented independently of any other aspects and that two or more of these aspects can be combined in various ways. For example, an apparatus can be implemented and/or a method practiced using any number of the aspects set forth herein. In addition, an apparatus can be implemented and/or a method practiced using other structure and/or functionality in addition to or other than one or more of the aspects set forth herein. As an example, many of the methods, devices, systems and apparatuses described herein are described in the context of providing network arbitration to support high quality wireless communication. One skilled in the art should appreciate that similar techniques could apply to other communication environments.

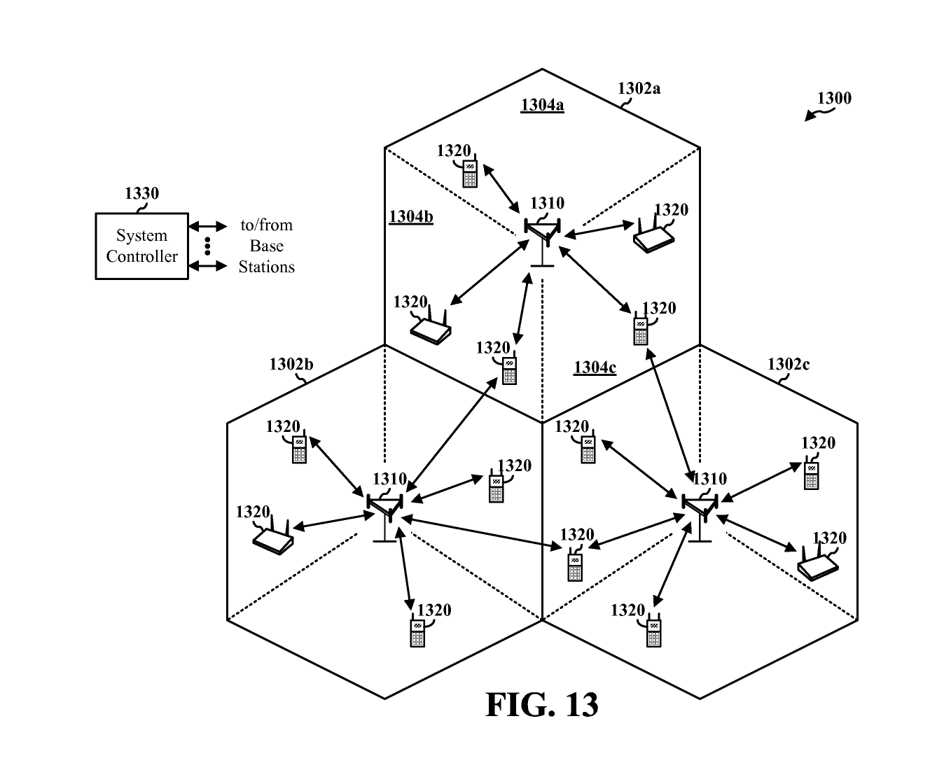

Modern deployments of wireless infrastructure providing wireless communication services to mobile devices can include homogeneous wireless networks as well as heterogeneous wireless networks. Homogeneous wireless networks are typically planned base station deployments, where a wireless operator constructs permanent or semi-permanent base station infrastructure in a coordinated fashion in a geographic region, to provide seamless wireless services for mobile communication devices that travel throughout the geographic region. In addition to position of such base station infrastructure, the wireless operator can also control transmit power of respective base stations, as well as beamshaping or similar techniques, to reduce interference among smaller regions, or cells, of the geographic region (e.g., see FIG. 13, infra). Heterogeneous deployments can also be planned, where the wireless operator positions base station infrastructure of various size and power within the geographic region. In addition, heterogeneous deployments can also comprise semi-planned or un-planned deployments, where at least a subset of base station infrastructure is installed by consumers of wireless services. Particularly, home Node B (HNB) base stations (also referred to herein as Femto base stations, Femto access points [FAPs], or the like) can be installed by the consumers at various locations within the geographic region, including homes, office buildings, apartment buildings, and so forth. FAPs can employ wireless communication channels (e.g., licensed radio frequency channels, or potentially WiFi channels, wireless microwave channels, or other suitable wireless communication channels) to communicate with wireless communication devices, and are generally coupled with a broadband Internet connection (e.g., a digital subscriber line [DSL], cable Internet line, broadband over power line, satellite Internet, or the like) to communicate with a wireless core network gateway, or a wireless operator's network gateway, or a suitable combination thereof. Accordingly, the FAPs can provide wireless communication services based on a link with a core network or operator's network, as well as a wireless link with a mobile communication device.

One design aspect for heterogeneous networks comprising FAPs involves providing different quality of service (QoS) levels for different types of traffic. Examples of different QoS can include best effort QoS, as well as specific QoS or elevated QoS, having minimum characteristics (e.g., jitter, transfer rate, packet transfer success, priority, and so on). As an example, a FAP can be coupled to a Femto Gateway (a FGW) by a broadband Internet connection, and the Internet, referred to as a broadband Internet link, or just a broadband link. The FAP and FGW can provide multiple QoS levels required for various types of QoS traffic in a data stream employed by a mobile device. In addition, the different QoS levels can be established by a security association (SA) provided by the broadband link.

Different types or classes of traffic can be sent over the broadband link with a particular SA provided by the broadband link. However, this can result in inappropriate loss of data packets of lower priority, due to windowing mechanisms and limited memory employed by broadband links. To alleviate this problem, the FAP and FGW can assign higher QoS traffic to an elevated SA to reduce likelihood of packet loss for the higher QoS traffic. In this manner, multiple SAs can be employed to provide appropriate QoS services. Further, traffic from multiple mobile devices but belonging to a common QoS classification can use a common SA that provides a QoS correlated to requirements of the traffic.

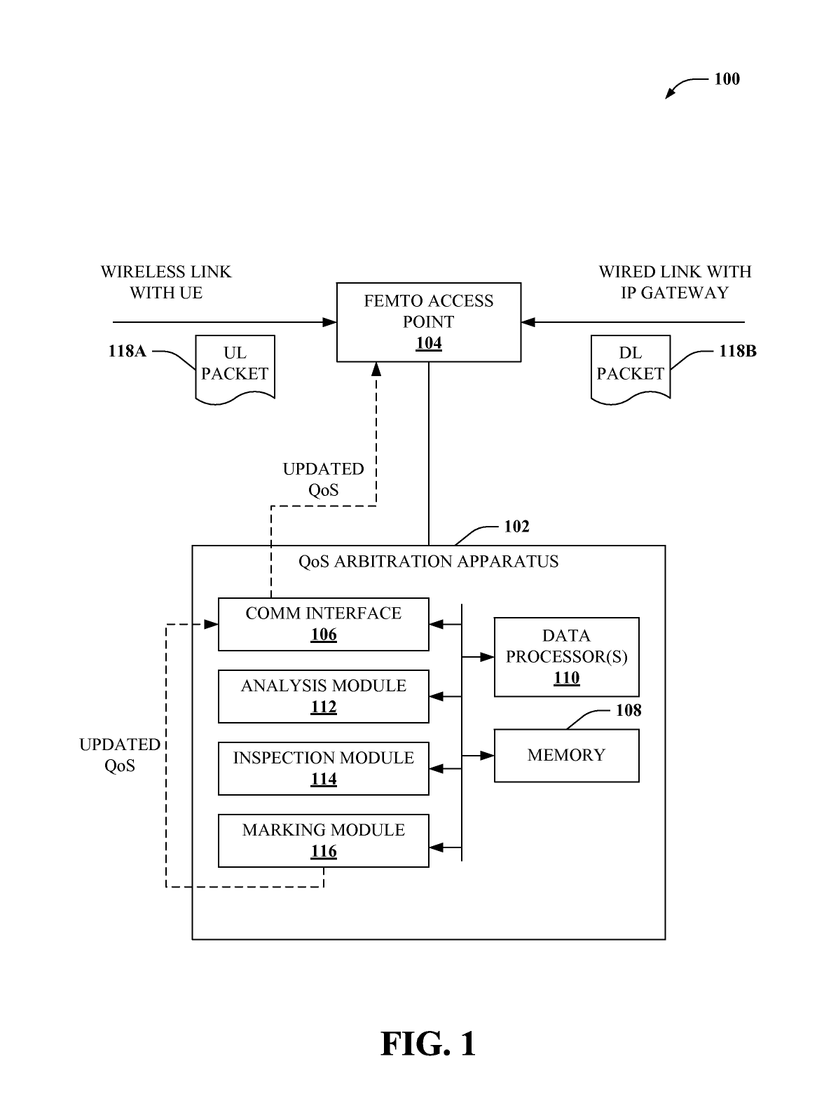

FIG. 1 depicts a block diagram of an example system 100 that provides QoS for wireless communication according to aspects of the subject disclosure. System 100 comprises a FAP 104 coupled with a QoS arbitration apparatus 102. FAP 104 is coupled with a wireless link for providing wireless communication services for a user equipment (a UE—not depicted). Additionally, FAP 104 is coupled with a wired link to an IP gateway, such as a FGW. Traffic received over the wireless link is termed uplink traffic (UL traffic), and can comprise an UL data packet 118A transmitted by the UE. Furthermore, traffic received over the wired link is termed downlink traffic (DL traffic) and can comprise a DL data packet 118B. Additionally, QoS arbitration apparatus 102 can provide an appropriate level of QoS for UL data packet 118A or DL data packet 118B, based at least in part on a QoS assigned to reverse link traffic (e.g., DL data packet 118B or the UL data packet 118A, respectively).

QoS arbitration apparatus 102 can comprise a communication interface 106 configured for electronic communication with FAP 104. Accordingly, communication interface 106 can obtain UL data packet 118A or DL data packet 118B for analysis by QoS arbitration apparatus 102. Alternatively, communication interface 106 can comprise a wireless interface of FAP 104 for communication over the wireless link, or a wired interface for communication over the wired link. In such case, QoS arbitration apparatus 102 can receive and analyze the data packets directly. In either case, in at least one aspect, communication interface 106 can be configured as an interface that electronically communicates with a broadband link (e.g., the wired link) and with a wireless link, wherein communication interface 106 obtains downlink traffic (DL traffic) from the broadband link and obtains uplink traffic (UL traffic) from the wireless link of FAP 104.

In addition to the foregoing, QoS arbitration apparatus 102 can comprise memory 108 or storing instructions configured to establish quality of service (QoS) policies for the DL traffic or the UL traffic and a data processor 110 for executing modules that implement the instructions. Specifically, the modules can include an analysis module 112 that identifies a set of UL traffic and a set of DL traffic pertaining to a communication stream. Analysis module 112 can distinguish traffic involving one UE of a group of UEs served by FAP 104, for instance. Furthermore, analysis module 112 can distinguish one communication stream (e.g., a web-browsing stream) from a second communication stream (e.g., voice traffic) employed by the UE. Analysis module 112 can also identify traffic routed in a forward direction and a reverse direction of respective communication streams. Thus, as one particular example, analysis module 112 can identify DL data packet 118B as reverse link traffic pertaining to UL data packet 118A, and vice versa.

Additionally, QoS arbitration apparatus 102 can comprise an inspection module 114 that identifies a QoS level associated with a data packet of the communication stream. Inspection module 114 can analyze UL data packet 118A, for instance, for a differential code services point (DSCP) flag specifying the QoS level, a user datagram protocol (UDP) flag specifying the QoS level, a generic routing encapsulation (GRE) flag specifying the QoS level, a transport control protocol (TCP) flag specifying the QoS level, or the like, or a suitable combination thereof. A marking module 116 can be executed by data processor 110. Marking module 116 can be configured to be a module that updates the QoS level of UL data packet 118A, or of DL data packet 118B, identified by inspection module 114. Specifically, marking module 116 can update the identified QoS level if the QoS level is inconsistent with a reverse direction QoS level of a reverse direction data packet of the communication stream routed in an opposite direction as the data packet.

The following examples are provided to illustrate potential applications of reverse link QoS marking by QoS arbitration apparatus 102. It should be appreciated, however, that the subject disclosure is not limited to these examples, as other examples can exist that are within the scope of the subject disclosure. As a first example, the data packet updated by marking module 116 is UL data packet 118A obtained from a UE over the wireless link with FAP 104. In this example, the reverse direction data packet is DL data packet 118B obtained from a FGW over the wired link with FAP 104 (a broadband link). As a second example, the data packet updated by marking module 116 is DL data packet 118B obtained from the FGW over the broadband link, and the reverse direction data packet is UL data packet 116A obtained from the UE over the wireless link.

Further, it should be appreciated that marking module 116 can update the QoS level of the data packet to one of various QoS levels provided by a QoS profile employed by the broadband link, and assigned to the reverse link data packet. In one instance, the QoS level is one of a default level for best effort traffic or an elevated level for high priority traffic. As a more particular example, the high priority traffic the high priority traffic can be traffic that comprises voice traffic or streaming video or streaming audio traffic.

In the various examples, it should be appreciated that in at least one aspect marking module changes the QoS level of the data packet (whether UL data packet 116A or DL data packet 116B) to the reverse direction QoS level if the reverse direction QoS level is different from the QoS level. Thus, in at least this one aspect, marking module 116 can update an uplink QoS level of UL data packet 118A to be consistent with a downlink QoS level of DL data packet 118B, or vice versa. In an alternate aspect, marking module can establish an updated QoS level for the data packet, based on the reverse direction QoS level, and send the updated QoS level to FAP 104 via communication interface 106. In either case, QoS arbitration apparatus 102 enables dynamic correlation between UL and DL transmissions to provide consistent QoS treatment for a communication stream involving the UE.

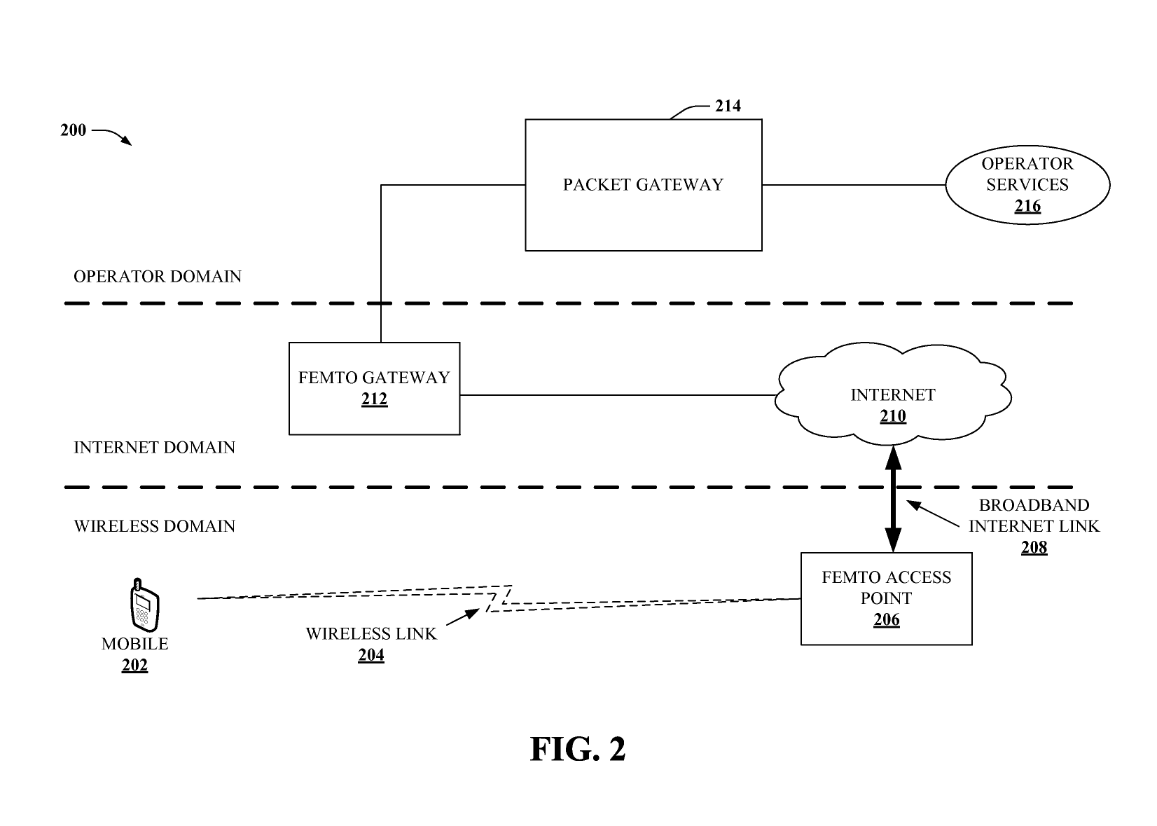

FIG. 2 illustrates a block diagram of an example networking environment 200 suitable for various aspects of the subject disclosure. Particularly, networking environment 200 can be employed for providing wireless voice or IP services to a mobile device 202 that is communicatively coupled to a FAP 206 via a wireless link 204. The wireless link 204 between mobile device 202 and FAP 206 exists in a wireless domain, wherein communication between mobile device 202 and FAP 206 is conducted with wireless transmission and reception of data. Further, the wireless transmission and reception of data can comprise voice traffic, including circuit-switched or packet-switched voice communication, or data traffic, which can comprise various types of information including web browsing traffic, media traffic, streaming media traffic, or the like, or a suitable combination thereof. In addition, it should be appreciated that control traffic can also be conveyed in the wireless domain, including transmit-receive scheduling, pilot signal acquisition, signal measurements, acknowledgment/negative acknowledgment of transmitted data, and so on.

In addition to the wireless domain, networking environment 200 also comprises an Internet domain. FAP 206 can communicate electronically with Internet 210 (which can alternatively or additionally comprise a private intranet, such as a corporate intranet, or another suitable wired or wireless network, and is not limited to the public Internet or world wide web) via a broadband Internet link 208. This broadband Internet link 208 can be a suitable Internet connection provided by an Internet service provider, utilizing at least in part a DSL line, a cable line, an optical fiber line, or a wireless broadband link such as a worldwide interoperability for microwave access (WiMAX) link, a WiFi link, or other suitable Internet (or intranet) connection. Through broadband Internet link 208, FAP 206 can exchange data packets between Internet 210 and mobile device 202. Data transmitted to Internet 210 can be addressed to a Femto gateway 212 within the Internet domain. Femto gateway 212 is a gateway configured to provide packet services to a mobile device coupled with FAP 206, for instance, by transmitting and receiving data packets associated with the packet services to and from Internet 210.

Networking environment 200 also comprises an operator domain, comprising a packet gateway 214 communicatively coupled with Femto gateway 212. Packet gateway 214 can comprise a packet data serving network (PDSN) or other suitable packet gateway. Through packet gateway 214, traffic can be exchanged with an operator's services network 216. Such services can include circuit-switched voice traffic (e.g., through a connection with the public switched telephone network), voice over Internet protocol (VoIP) traffic, streaming media, and so on. Thus, by coupling the wireless domain, Internet domain, and operator domain, mobile device 202 can connect to and obtain communication services of a wireless operator, or other network operator. Further, as described herein, a QoS level can be established dynamically for the communication services, which can be observed in all three domains, providing consistent quality for the communication services.

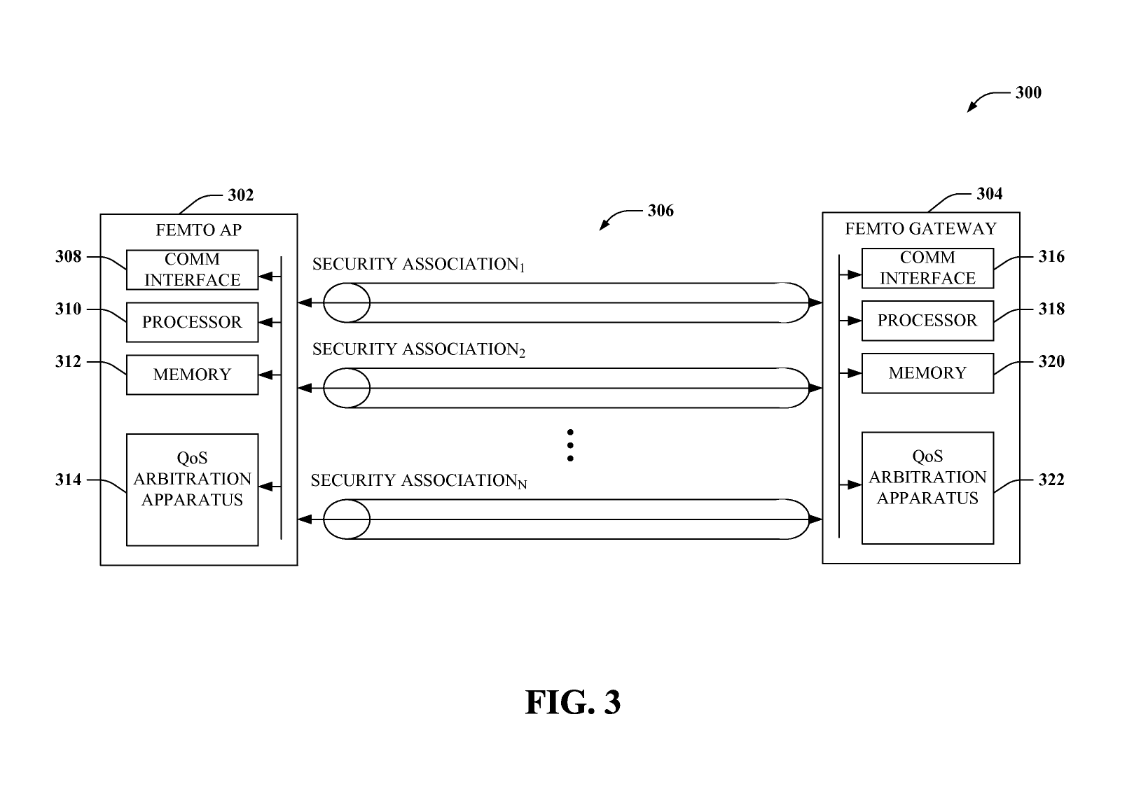

FIG. 3 depicts a block diagram of an example electronic communication environment 300 according to aspects of the subject disclosure. Electronic communication environment 300 can comprise a FAP 302 communicatively coupled with a FGW 304 via a broadband link comprising a set of SAs 306. Particularly, the set of SAs 306 can comprise a first SA, a second SA, . . . through an N^{th} SA, where N is an integer greater than one. The set of SAs 306 can be employed by FAP 302 and FGW 304 for providing consistent QoS for communication streams having different levels of QoS based on different types of traffic associated with the respective communication streams. Further, FAP 302 and FGW 304 can be configured to assign a data packet to one of the set of SAs 306 based at least in part on an SA assignment for reverse link data packets sharing a common communication stream with the data packet. Optionally, FAP 302 and FGW 304 can be configured to assign the data packet to one of the set of SAs 306 based at least in part on a type of traffic conveyed by the communication stream.

FAP 302 can comprise a communication interface 308 for transmitting and receiving data packets to and from FGW 304 over the broadband link. In addition, FAP 302 can comprise memory 312 for storing instructions related to assigning traffic to respective ones of the SAs 306, and a data processor 310 for executing a QoS arbitration apparatus 314 to implement the instructions. In at least one aspect of the subject disclosure, QoS arbitration apparatus 314 can be substantially similar to QoS arbitration apparatus 102 of FIG. 1, supra. However, the subject disclosure is not so limited.

According to particular aspects, QoS arbitration apparatus 314 can analyze a QoS assigned to a data packet. Additionally, QoS arbitration apparatus 314 can analyze reverse link traffic received from FGW 304 and identify a QoS assigned to the reverse link traffic. If the QoS assigned to the data packet is the same as the QoS assigned to the reverse link traffic, QoS arbitration apparatus 314 transmits the data packet on an SA correlated with the QoS assigned to the data packet. Otherwise, QoS arbitration apparatus 314 modifies the QoS assigned to the data packet to match the QoS of the reverse link traffic, and transmits the data packet on an SA correlated with the QoS of the reverse link traffic.

In at least one aspect of the subject disclosure, QoS arbitration apparatus 314 can establish a priority for the data packet equivalent to the SA correlated to the QoS of the data packet, or the modified QoS equivalent to the QoS of the reverse link traffic. The priority can correspond to a transmission priority, for selecting data packets to be first transmitted from a queue (memory 312), a rate at which data packets are transmitted over the broadband link, or the like, as well as which one of the set of SAs 306 the data packet is transmitted over. Accordingly, more sensitive traffic such as voice traffic or streaming media traffic (e.g., streaming video, streaming audio, etc.) can be transmitted before less sensitive traffic (e.g., web-browsing traffic), at a higher rate, or with lower jitter or packet loss, based on the SA employed for the transmission. Accordingly, QoS arbitration apparatus 314 can employ the set of SAs 306 to provide priority and SA for the data packet that matches an updated QoS level established by QoS arbitration apparatus 314.

In addition to the foregoing, FGW 304 can also comprise a communication interface 316 for transmitting and receiving data packets to and from, respectively, FAP 302 via the broadband link. Further, FGW 304 can transmit the data packets on selected ones of the set of SAs 306 that correspond with reverse link traffic correlated with respective data packets. Particularly, FGW 304 can comprise memory 320 for storing instructions configured to establish appropriate QoS for the data packets and a data processor 318 for executing QoS arbitration apparatus 322 to implement the instructions. QoS arbitration apparatus 322 can be substantially similar to QoS arbitration apparatus 314 in at least some aspects of the subject disclosure; however, QoS arbitration apparatus 314 can also be configured differently from QoS arbitration apparatus 314 in other aspects.

Thus, in one example, FGW 304 can receive a data packet as part of a DL stream from an IP gateway (not depicted, but see FIG. 2, supra), and receive reverse link traffic (UL traffic) as part of an UL stream over the broadband link from FAP 302. Alternatively, FGW 304 can receive the data packet as part of an UL stream from FAP 302 over the broadband link, and receive reverse link traffic as part of a DL stream from the IP gateway. Further, a combination of the foregoing can be implemented, where respective UL data packets and DL data packets have corresponding reverse link traffic within a common communication stream (e.g., as described at FIG. 1, supra). Accordingly, FGW 304 can participate with FAP 302 in providing uniform QoS for the common communication stream. Alternatively, FGW 304 can instead allow QoS to be modified by FAP 302, as described above, and simply employ a QoS level established for UL and DL data packets set by FAP 302. As yet another alternative, FGW 304 can set the QoS for UL and DL data packets, and FAP 302 can simply employ the QoS level established by FGW 304, instead.

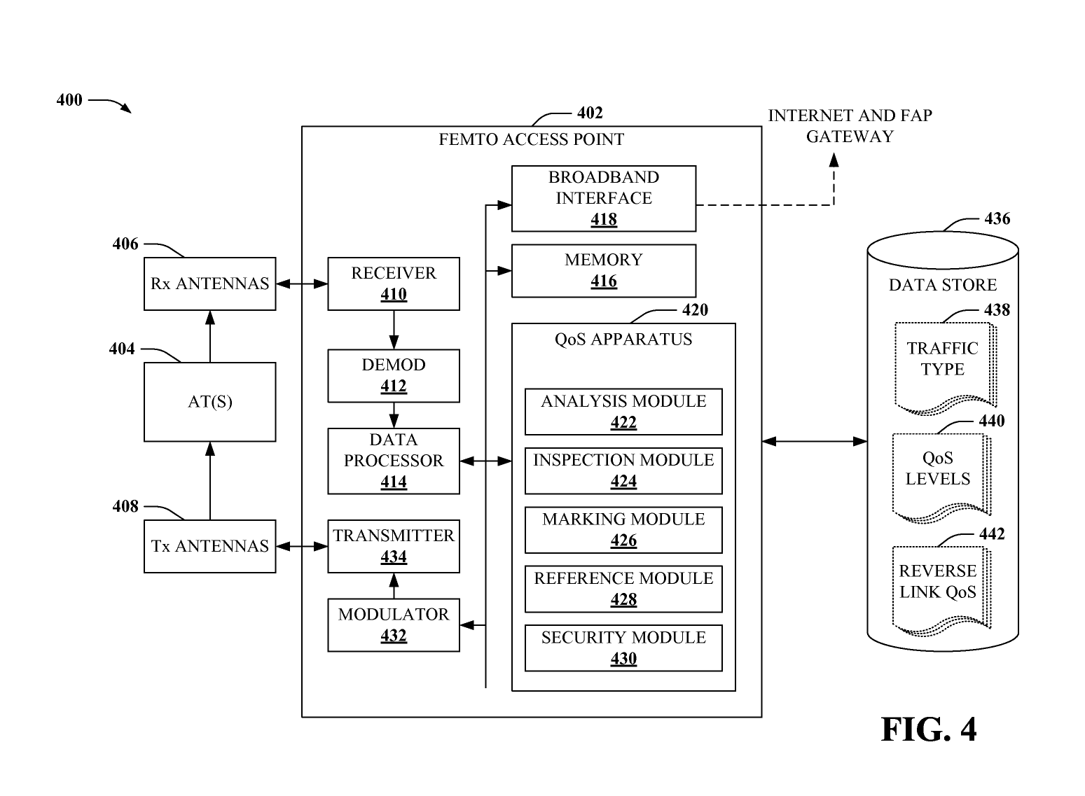

FIG. 4 illustrates a block diagram of an example system 400 comprising a FAP 402 according to particular aspects of the subject disclosure. FAP 402 can be configured to provide or modify QoS assignments of data packets transmitted over a broadband link with a FGW, as described herein. Particularly, FAP 402 can be configured to analyze a QoS level of a received data packet, and compare the QoS level to reverse direction QoS for reverse link traffic associated with the data packet. Based at least in part on the comparison, FAP 402 can modify the QoS level, where necessary, to be consistent with the reverse direction QoS, optionally based on a type of traffic carried by the data packet (e.g., voice traffic, browsing traffic, and so on).

FAP 402 (e.g., Femto base station, . . . ) can comprise a receiver 410 that obtains wireless signals from AT(s) 404 through one or more receive antennas 406, and a transmitter 434 that sends coded/modulated wireless signals provided by modulator 432 to the AT(s) 404 through a transmit antenna(s) 408. Receive antenna(s) 406 and transmit antenna(s) 408, along with receiver 410 and transmitter 422, can comprise a set of wireless transceivers for wireless communication with AT(s) 404, as described herein.

Receiver 410 can obtain information from receive antennas 406 and can further comprise a signal recipient (not shown) that receives uplink data transmitted by AT(s) 404. Additionally, receiver 410 is operatively associated with a demodulator 412 that demodulates received information. Demodulated symbols are analyzed by a data processor 414. Data processor 414 is coupled to a memory 416 that stores information related to functions provided or implemented by FAP 402. Additionally, FAP 402 can comprise a broadband interface 418 that can establish electronic communication with a FGW for providing telephone or data services for AT(s) 404. Furthermore, FAP 402 can comprise a QoS apparatus 420 that establishes consistent QoS over the broadband link.

Particularly, QoS apparatus 420 can comprise an analysis module 422 that identifies a set of UL traffic and a set of DL traffic pertaining to a communication stream, and an inspection module 424 that identifies a QoS level associated with a data packet of the communication stream. Inspection module 424 can also identify a reverse direction QoS assigned to a data packet of the communication stream routed in an opposite direction as the data packet. If the QoS level is inconsistent with the reverse direction QoS level, a marking module 426 can be employed that updates the QoS level with the reverse direction QoS level. In at least one aspect of the subject disclosure, marking module 426 updates the QoS level of the data packet by encapsulating the data packet in an IP header that includes the updated QoS level. Specifically, this updated QoS level can be specified as a value of a differential services code point flag within the IP header, or other suitable flag (e.g., a TCP flag).

In at least one aspect of the subject disclosure, QoS apparatus 420 can comprise a reference module 428 that generates a data table within a data store 436 that correlates a type of traffic associated with the communication stream with the reverse direction QoS level. According to this aspect, analysis module 422 stores the QoS level of a received data packet into a QoS level file 440, and furthermore can store a reverse direction QoS into a reverse link QoS file 442. In at least one aspect of the subject disclosure, analysis module 422 determines the QoS level from a DSCP flag, a GRE flag, a UDP flag, a TCP flag, or other suitable flag or marker of the received data packet. Additionally, inspection module 424 can analyze the data packet and reverse link data packets to identify a traffic type conveyed by the data packet and reverse link data packets, and store the traffic type into a traffic type file 438. Furthermore, the traffic type file 438 of respective communication streams can be correlated with a QoS level stored in QoS level file 440 and reverse direction QoS stored in reverse link QoS file 442. This correlation can be utilized to generate a dataset that correlates particular types of traffic to suitable QoS levels, based at least in part on the reverse direction QoS. Further, the dataset can track improperly marked data packets by also correlating the QoS level of data packets to respective traffic types and reverse direction QoS, yielding a dynamic data-based representation of traffic and quality. In this aspect of the subject disclosure, marking module 426 can be configured to be a module that references the data table or dataset to determine whether to update a second QoS level of data packets of a second communication stream based on whether the second communication stream carries a type of traffic stored in the data table.

In still other aspects of the subject disclosure, QoS apparatus 420 can comprise a security module 430. Security module 430 can be configured to be a module that establishes a priority and SA for a data packet that matches an updated QoS level of the data packet established by marking module 426. This can increase a likelihood that the data packet receives appropriate transmission security and transmission priority commensurate with requirements of the updated QoS level. Thus, where a network service provider or an AT 404 improperly marks a QoS level of the data packet, QoS apparatus 420 can modify the QoS level as described herein, and transmit the data packet over the broadband link with proper QoS, security and priority. As a result, FAP 402 can facilitate improved quality for broadband-based wireless communication services in a heterogeneous communication network.

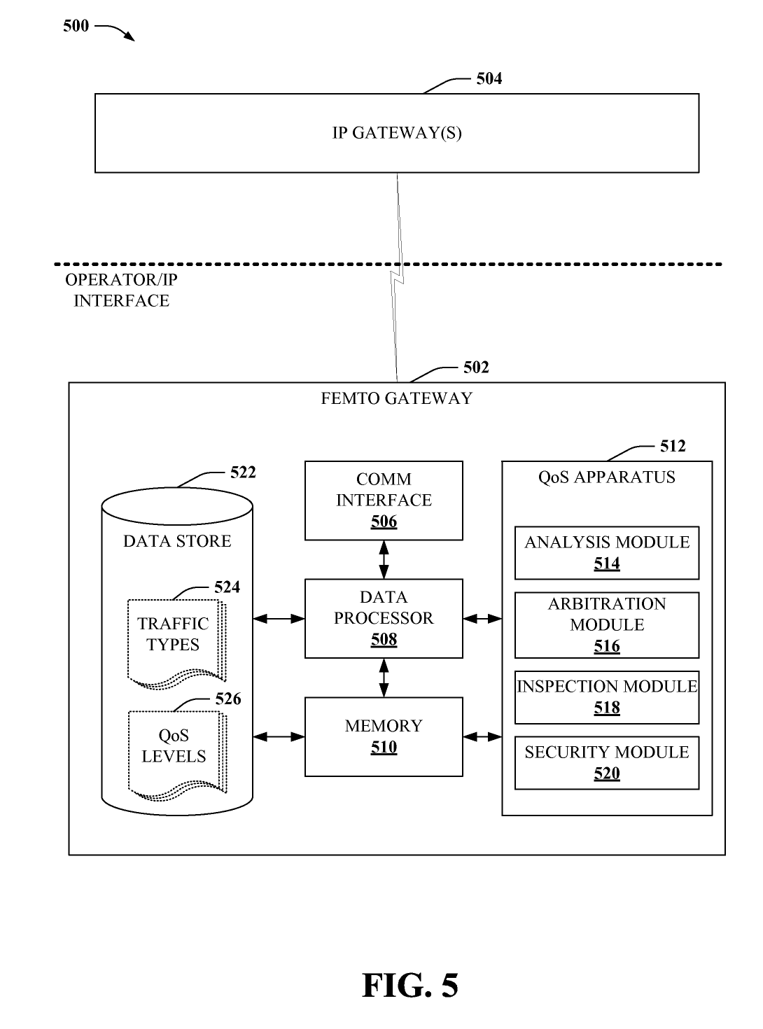

FIG. 5 illustrates a block diagram of an example communication environment 500 according to still other aspects of the subject disclosure. Communication environment 500 comprises a FGW 502 coupled with one or more IP gateways 504 (e.g., a PDSN gateway) via an operator/IP interface (e.g., see FIG. 2, supra). Specifically, FGW 502 can comprise a communication interface 506 that communicatively couples FGW 502 to IP gateway(s) 504 via an IP link. Although not depicted, communication interface 506 can also communicatively couple FGW 502 with a FAP via a broadband Internet link. FGW 502 can further comprise memory 510 for storing instructions configured to establish appropriate QoS for a data packet of a communication stream and a data processor for executing a QoS apparatus 512 that implements the instructions. Particularly, QoS apparatus 512 can provide QoS, priority, or SA for the data packet that is likely to be suitable to a type of traffic conveyed by the data packet, as described herein.

QoS apparatus 512 can comprise an analysis module 514 that determines a current QoS specified for the data packet, and can store the current QoS in a QoS level file 526 of a data store 522. Moreover, QoS apparatus 512 can comprise an arbitration module 516 that modifies the current QoS if a reverse direction QoS specified in a data packet of the communication stream that is routed in an opposite direction as the data packet is different from the current QoS. In one aspect, the data packet is a downlink data packet received from IP gateway(s) 504, and the data packet routed in the opposite direction is uplink traffic transmitted by a FAP over a broadband Internet link. In another example, the data packet is an uplink data packet received from the FAP over the broadband Internet link, and the data packet routed in the opposite direction is downlink traffic transmitted by IP gateway(s) 504.

To facilitate QoS modification, QoS apparatus 512 can comprise an inspection module 518 that analyzes traffic contained within the data packet and determines a type of the traffic. As one example, inspection module 518 determines the type of traffic to be voice traffic, streaming media traffic, or browsing traffic, or another suitable type of traffic, or a combination thereof. The type of traffic is stored in a data store 522 in a traffic type file 524.

As an implementation example, if the type of traffic is determined to be voice traffic, or the reverse direction QoS is a specific QoS suitable for voice traffic, arbitration module 516 modifies the current QoS to the specific QoS suitable for voice traffic. As another implementation example, if the reverse direction QoS is best effort QoS, or the traffic type is best effort traffic, arbitration module 516 modifies the current QoS to the best effort QoS suitable for the best effort traffic. As yet another implementation example, arbitration module 516 modifies the current QoS to a specific QoS suitable for streaming media traffic, if the traffic type is streaming media traffic, or if the reverse direction QoS is the specific QoS suitable for streaming media traffic.

In at least one aspect of the subject disclosure, a policy can be stored in memory 510 for modifying or maintaining the current QoS if the reverse direction QoS conflicts with a type of the traffic. As a particular example, arbitration module 516 can reference the policy to determine whether to modify a current QoS of best effort traffic, if the traffic type is best effort traffic and the reverse direction QoS is an elevated QoS (e.g., a QoS suitable for voice traffic or streaming media traffic). Thus, the policy might specify that the type of traffic overrules an inconsistent reverse direction QoS in one aspect, or the policy might specify that the reverse direction QoS overrules the type of traffic in another aspect. Other examples of policy rules can be implemented, for instance a policy that specifies the current QoS is to be modified only if the reverse direction QoS is consistent with the type of traffic. However, the subject disclosure is not limited to the foregoing examples of policy rules for conflicting reverse direction QoS and type of traffic.

In addition to the foregoing, QoS apparatus 512 can comprise a security module 520 that transmits a received data packet over a broadband Internet link with an SA correlated to the current QoS. Alternatively, security module 520 can transmit the received data packet with an SA correlated to a modified QoS if arbitration module 516 modifies the current QoS (e.g., to be consistent with a reverse direction QoS, or a type of traffic). In some aspects, the SA can be further correlated to a protocol type of the data packet, such as a generic routing encapsulation protocol, a user datagram protocol, or a transport control protocol, or the like. In either case, security module 520 can be configured to be a module that gives the data packet a priority correlated to the current QoS, or correlated to the modified QoS if the arbitration module 516 modifies the current QoS. Thus, security module 520 facilitates proper transmission of the data packet over the broadband Internet link with a FAP, or over the operator/IP interface with IP gateway(s) 504.

The aforementioned systems or apparatuses have been described with respect to interaction between several components, modules and/or communication interfaces. It should be appreciated that such systems and components/modules/interfaces can include those components/modules or sub-modules specified therein, some of the specified components/modules or sub-modules, and/or additional modules. For example, a system could include FGW 502 comprising QoS apparatus 512, IP gateway(s) 504, and FAP 104, coupled with QoS arbitration apparatus 102, or a different combination of these or other modules. Sub-modules could also be implemented as modules communicatively coupled to other modules rather than included within parent modules. Additionally, it should be noted that one or more modules could be combined into a single module providing aggregate functionality. For instance, analysis module 514 can include inspection module 518, or vice versa, to facilitate determining a current QoS and a type of traffic conveyed by a received data packet, by way of a single component. The components can also interact with one or more other components not specifically described herein but known by those of skill in the art.

Furthermore, as will be appreciated, various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, and in addition to that already described herein, can automate certain mechanisms or processes performed thereby to make portions of the systems and methods more adaptive as well as efficient and intelligent.

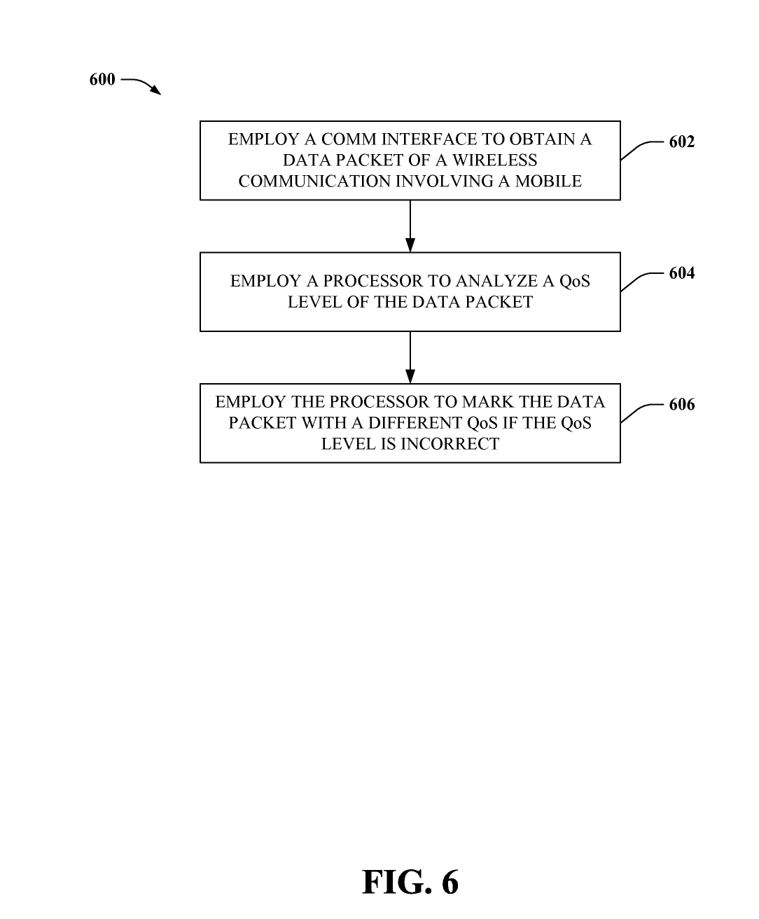

In view of the exemplary systems described supra, methodologies that may be implemented in accordance with the disclosed subject matter will be better appreciated with reference to the flow charts of FIGS. 6-9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, device in conjunction with a carrier, or storage medium.

FIG. 6 illustrates a flowchart of an example methodology 600 for providing QoS for broadband-based wireless services, according to aspects of the subject disclosure. At 602, method 600 can comprise employing a communication interface to obtain a data packet that is part of a wireless communication involving a mobile device. At 604, method 600 can comprise employing a processor to analyze the data packet to determine a QoS level established for the data packet. As one particular example, analyzing the data packet further comprises identifying an inner IP header of the data packet and identifying a value of a DSCP flag specified by the inner IP header. According to this example, determining the QoS level can further comprise comparing a value of the DSCP flag to a predetermined QoS ranking associated with the value of the DSCP flag.

At 606, method 600 can comprise employing the processor to mark the data packet with a different QoS level if the QoS level established for the data packet is incorrect. For instance, the processor can be employed for marking the data packet to a QoS level equivalent to that of reverse link QoS traffic of the wireless communication. As a particular example, wherein the QoS level is determined from the value of the DSCP flag for instance, marking the data packet further comprises generating an outer IP header for the data packet and marking the outer IP header with a DSCP value that corresponds with the different QoS level.

In one aspect, identifying whether the QoS level established for the data packet is incorrect further comprises analyzing reverse link traffic of the wireless communication. As an example, analyzing the reverse link traffic can also comprise determining whether the reverse link traffic requires an elevated QoS based at least in part on a type of the reverse link traffic. In this case, method 600 can comprise employing the elevated QoS for the different QoS level. As a more particular example, determining whether the reverse link traffic requires the elevated QoS can further comprise determining whether the type of the reverse link traffic is voice traffic or streaming media traffic.

In other aspects of the subject disclosure, determining whether the reverse link traffic requires the elevated QoS can further comprise generating a data table that correlates the type of the reverse link traffic to a reverse link QoS level specified by a data packet of the reverse link traffic. In this case, determining whether the QoS level established for the data packet is incorrect further comprises referencing the data table and comparing the data packet and the QoS level to the type of the reverse link traffic and the reverse link QoS level.

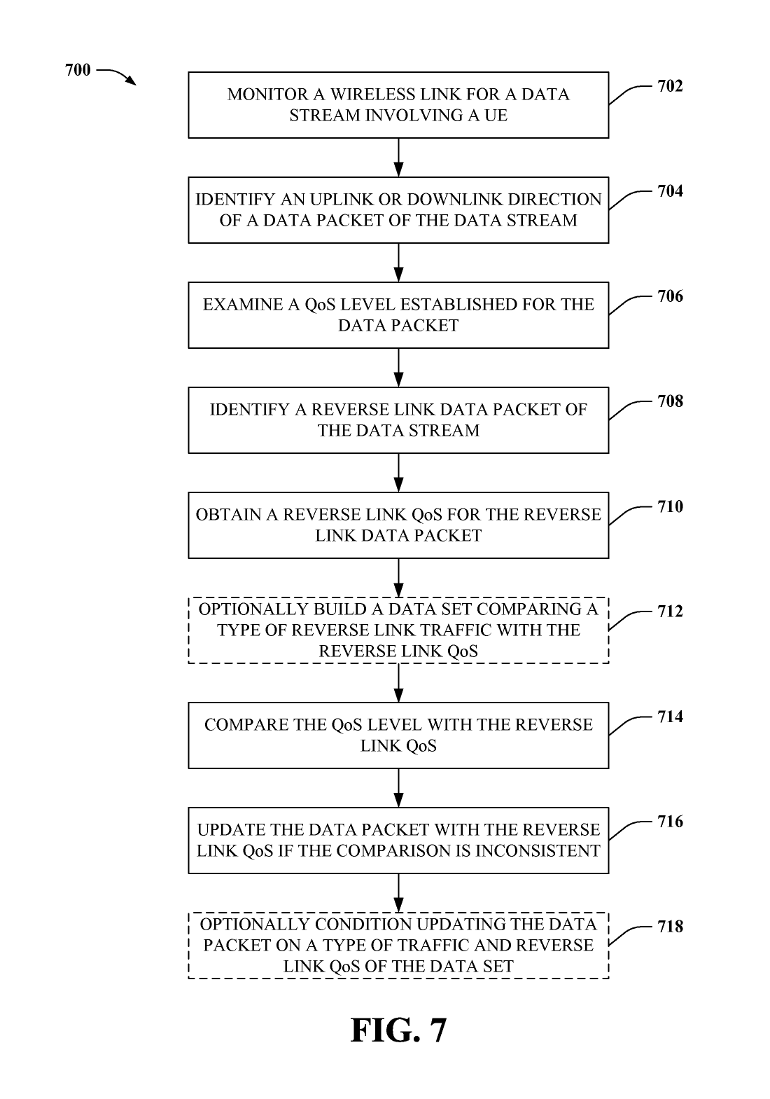

FIG. 7 illustrates a flowchart of an example methodology 700 according to still other aspects of the subject disclosure. At 702, method 700 can comprise monitoring a wireless link for a data stream involving a UE. At 704, method 700 can comprise identifying an UL or DL direction of a data packet of the data stream. At 706, method 700 can comprise examining a QoS level established for the data packet. Further, at 708, method 800 can comprise identifying a reverse link data packet of the data stream. Particularly, the reverse link data packet is a data packet routed in an opposite direction as the data packet. Thus, if the data packet is an UL data packet, the reverse link data packet will be a DL data packet, and vice versa.

At 710, method 700 can comprise obtaining a reverse link QoS for the reverse link data packet. At 712, method 700 can optionally comprise building a data set that compares a type of the reverse link traffic with the reverse link QoS. At 714, method 700 can comprise comparing the QoS level of the data packet with the reverse link QoS of the reverse link data packet. At 716, method 700 can comprise updating the data packet with the reverse link QoS if the comparison shows the QoS level and the reverse link QoS are inconsistent. Optionally, at 718, method 700 can comprise conditioning updating the data packet on the type of traffic and the reverse link data packet specified by the data set being consistent with a predetermined QoS for the type of traffic.

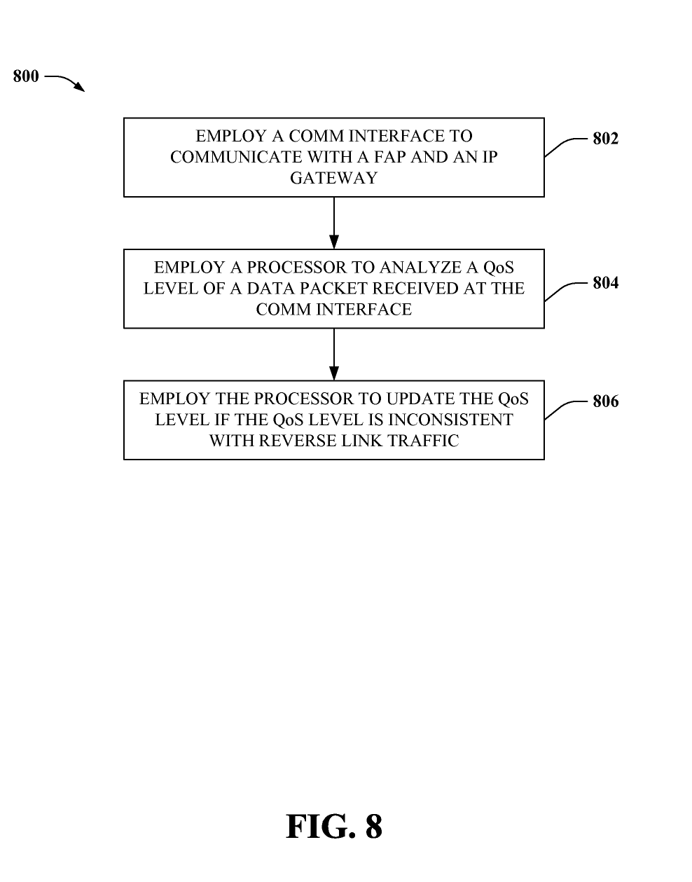

FIG. 8 depicts a flowchart of a sample methodology 800 for providing consistent QoS in Femto-based wireless communication according to additional aspects of the subject disclosure. At 802, method 800 can comprise employing a communication interface for electronic communication with a FAP via a broadband link and with an IP gateway over an IP network link. Additionally, at 804, method 800 can comprise employing a data processor to analyze a QoS level of a data packet of a communication stream received at the communication interface. In one aspect, analyzing the QoS level can further comprise determining the QoS level from an IP header of the data packet. For instance, the QoS level can be specified as part of a UDP flag of the IP header, or as part of a DSCP flag of the IP header, or another suitable flag within the IP header. Further to the above, at 806, method 800 can comprise employing the data processor to update the QoS level if the QoS level is inconsistent with reverse link traffic of the communication stream.

As a particular example, method 800 can comprise receiving the data packet as part of a DL stream of the communication stream from the IP gateway, and receiving reverse link traffic as part of an UL stream of the communication stream over the broadband link from the FAP. Alternatively, method 800 can instead comprise receiving the data packet as part of an UL stream of the communication stream from the FAP over the broadband link, and receiving the reverse link traffic as part of a DL stream of the communication stream from the IP gateway. In at least one aspect, a combination of the foregoing can be implemented by method 800.

According to at least one aspect of the subject disclosure, updating the QoS level further comprises wrapping the data packet in an outer IP header and marking the outer IP header with an updated QoS level. Particularly, this aspect can be employed wherein the updated QoS level is an equivalent QoS level as a reverse link QoS specified by the reverse link traffic. Accordingly, updating the QoS level further comprises changing the QoS level specified for the data packet to a reverse link QoS value specified by the reverse link traffic.

According to another disclosed aspect, method 800 can comprise building a dataset of reverse link QoS as a function of type of traffic for a plurality of communication streams. In this aspect, method 800 comprises determining a reverse link QoS of the reverse link traffic at least in part from the dataset. Optionally, updating the QoS level of the data packet can be conditioned on the reverse link QoS being appropriate for a type of traffic associated with the communication stream.

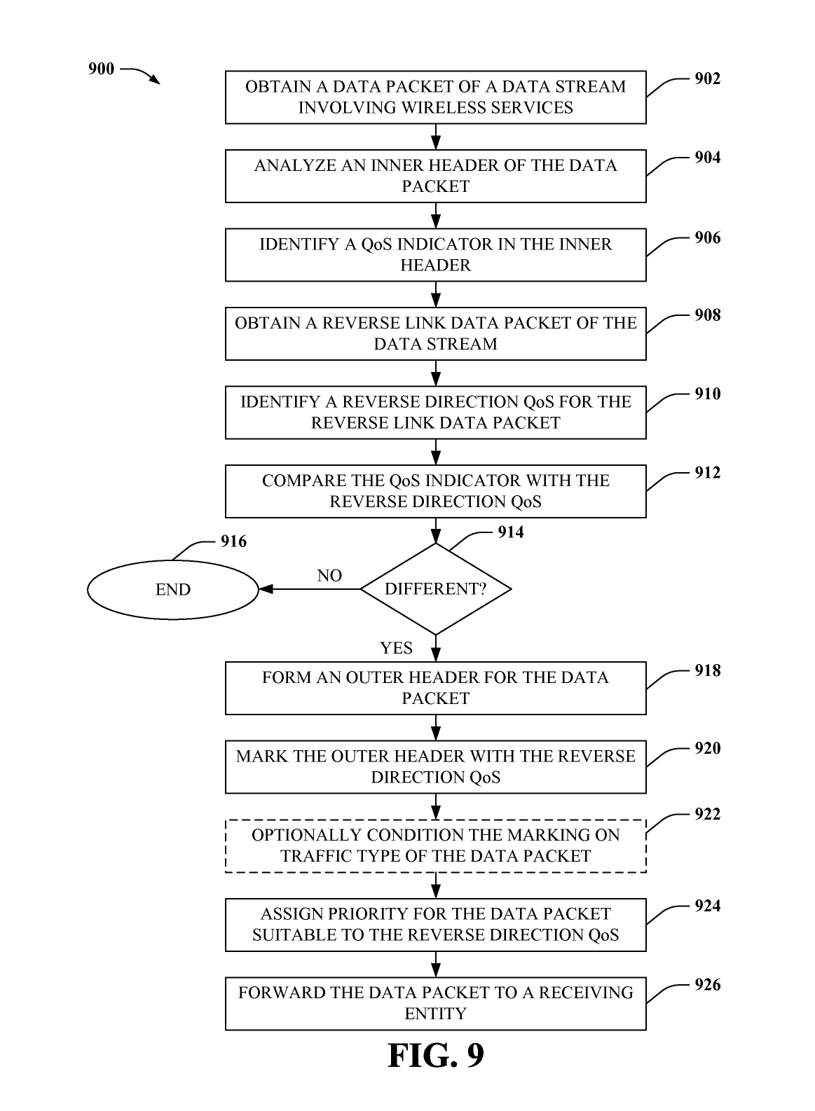

FIG. 9 illustrates a flowchart of an example methodology 900 according to still other aspects of the subject disclosure. At 902, method 900 can comprise obtaining a data packet of a data stream involving wireless services employed by a UE. At 904, method 900 can comprise analyzing an inner IP header of the data packet. At 906, method 900 can comprise identifying a QoS indicator in the inner IP header.

Further, at 908, method 900 can comprise obtaining a reverse link data packet of the data stream. At 910, method 900 can comprise identifying a reverse direction QoS for the reverse link data packet. At 912, method 900 can comprise comparing the QoS indicator with the reverse direction QoS. At 914, a determination is made as to whether the QoS indicator is different from the reverse direction QoS. If so, method 900 proceeds to 918. Otherwise, method 900 ends at 916.

At 918, method 900 can comprise forming an outer IP header for the data packet. At 920, method 900 can comprise marking the outer IP header with the reverse direction QoS. At 922, method 900 can optionally comprise conditioning marking the outer IP header on a traffic type of the data packet being consistent with the reverse direction QoS. At 924, method 900 can comprise assigning a priority for the data packet suitable to the reverse direction QoS. At 926, method 900 can comprise forwarding the data packet to a receiving entity at the assigned priority.

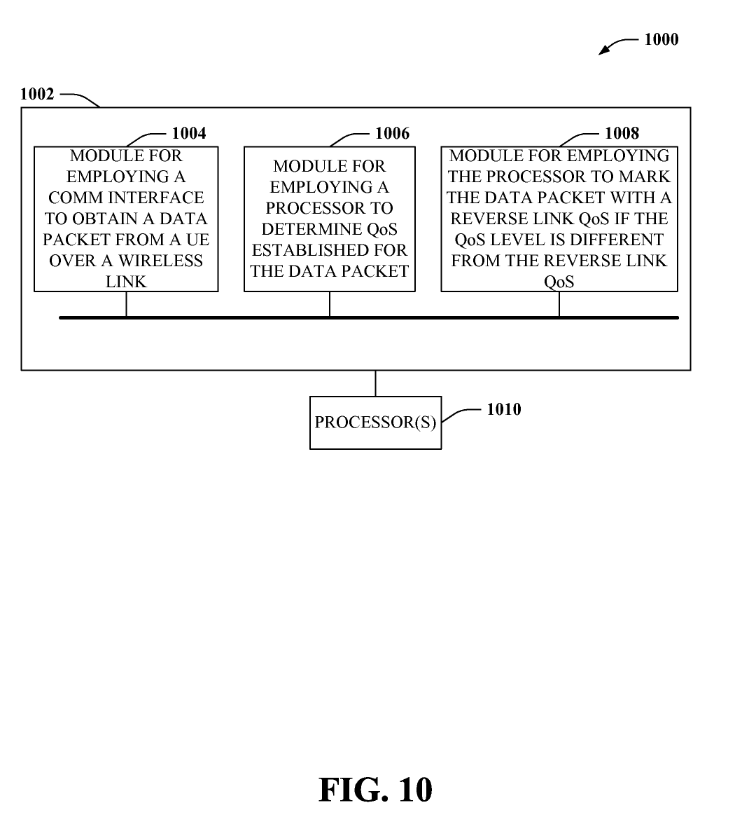

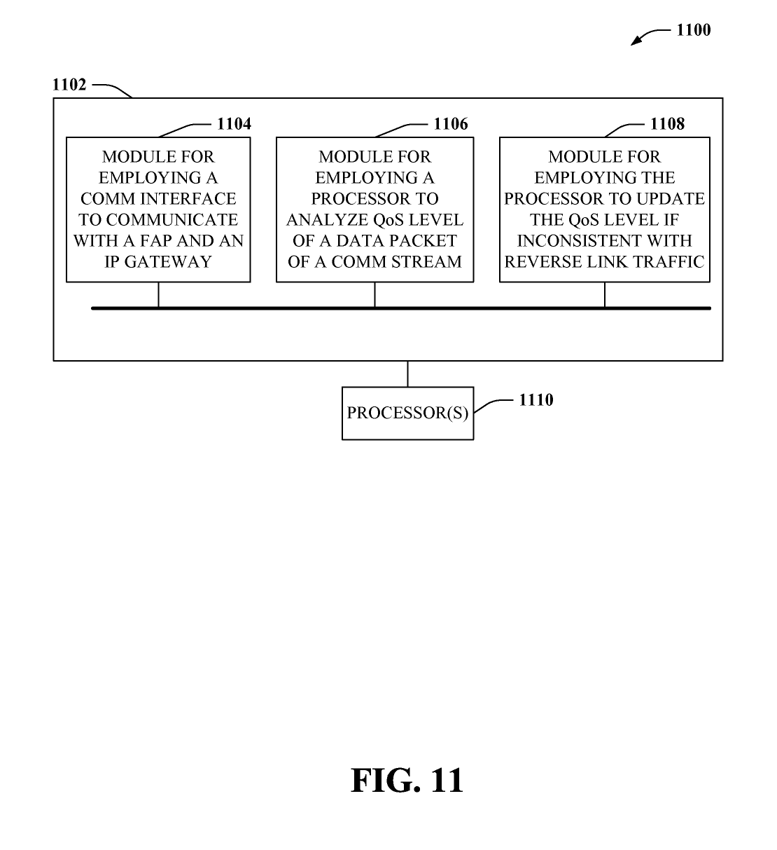

FIGS. 10 and 11 illustrate respective example systems 1000, 1100 for implementing improved acknowledgment and re-transmission protocols for wireless communication according to aspects of the subject disclosure. For instance, systems 1000, 1100 can reside at least partially within a wireless communication network and/or within a wireless receiver such as a node, base station, access point, user terminal, personal computer coupled with a mobile interface card, or the like. It is to be appreciated that systems 1000, 1100 are represented as including functional blocks, which can be functional blocks that represent functions implemented by a processor, software, or combination thereof (e.g., firmware).

System 1000 can comprise memory 1002 for storing modules configured to execute functions of system 1000. Particularly, system 1000 can comprise a module 1004 for employing a communication interface to obtain a data packet from a mobile device over a wireless link. Additionally, system 1000 can comprise a module 1006 for employing a processor 1010 to analyze the data packet to determine a QoS level established for the data packet. Further to the above, system 1000 can also comprise a module 1008 for employing processor 1010 to mark the data packet with a reverse link QoS level of a reverse link data packet if the QoS level established for the data packet is different from the reverse link QoS level.

System 1100 can comprise memory 1102 for storing modules configured to execute functions of system 1100. The modules can include a module 1104 for employing a communication interface for electronic communication with a FAP over a broadband link and with an IP gateway over an IP network link. Additionally, system 1100 can comprise a module 1106 for employing a data processor 1110 to analyze a QoS level of a data packet of a communication stream received at the communication interface. Moreover, system 1100 can comprise a module 1108 for employing data processor 1110 to update the QoS level if the QoS level is inconsistent with reverse link traffic of the communication stream.

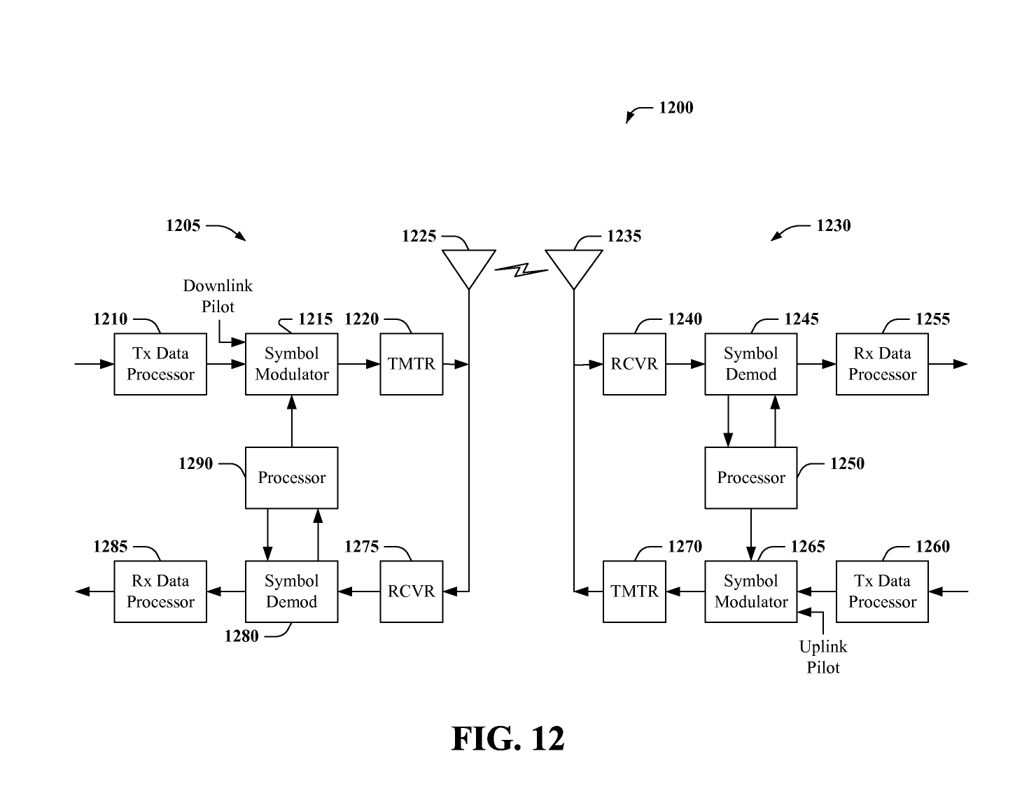

FIG. 12 depicts a block diagram of an example system 1200 that can facilitate wireless communication according to some aspects disclosed herein. On a downlink, at access point 1205, a transmit (TX) data processor 1210 receives, formats, codes, interleaves, and modulates (or symbol maps) traffic data and provides modulation symbols (“data symbols”). A symbol modulator 1215 receives and processes the data symbols and pilot symbols and provides a stream of symbols. A symbol modulator 1215 multiplexes data and pilot symbols and provides them to a transmitter unit (TMTR) 1220. Each transmit symbol can be a data symbol, a pilot symbol, or a signal value of zero. The pilot symbols can be sent continuously in each symbol period. The pilot symbols can be frequency division multiplexed (FDM), orthogonal frequency division multiplexed (OFDM), time division multiplexed (TDM), code division multiplexed (CDM), or a suitable combination thereof or of like modulation and/or transmission techniques.

TMTR 1220 receives and converts the stream of symbols into one or more analog signals and further conditions (e.g., amplifies, filters, and frequency upconverts) the analog signals to generate a downlink signal suitable for transmission over the wireless channel. The downlink signal is then transmitted through an antenna 1225 to the terminals. At terminal 1230, an antenna 1235 receives the downlink signal and provides a received signal to a receiver unit (RCVR) 1240. Receiver unit 1240 conditions (e.g., filters, amplifies, and frequency downconverts) the received signal and digitizes the conditioned signal to obtain samples. A symbol demodulator 1245 demodulates and provides received pilot symbols to a processor 1250 for channel estimation. Symbol demodulator 1245 further receives a frequency response estimate for the downlink from processor 1250, performs data demodulation on the received data symbols to obtain data symbol estimates (which are estimates of the transmitted data symbols), and provides the data symbol estimates to an RX data processor 1255, which demodulates (i.e., symbol demaps), deinterleaves, and decodes the data symbol estimates to recover the transmitted traffic data. The processing by symbol demodulator 1245 and RX data processor 1255 is complementary to the processing by symbol modulator 1215 and TX data processor 1210, respectively, at access point 1205.

On the uplink, a TX data processor 1260 processes traffic data and provides data symbols. A symbol modulator 1265 receives and multiplexes the data symbols with pilot symbols, performs modulation, and provides a stream of symbols. A transmitter unit 1270 then receives and processes the stream of symbols to generate an uplink signal, which is transmitted by the antenna 1235 to the access point 1205. Specifically, the uplink signal can be in accordance with SC-FDMA requirements and can include frequency hopping mechanisms as described herein.

At access point 1205, the uplink signal from terminal 1230 is received by the antenna 1225 and processed by a receiver unit 1275 to obtain samples. A symbol demodulator 1280 then processes the samples and provides received pilot symbols and data symbol estimates for the uplink. An RX data processor 1285 processes the data symbol estimates to recover the traffic data transmitted by terminal 1230. A processor 1290 performs channel estimation for each active terminal transmitting on the uplink. Multiple terminals can transmit pilot concurrently on the uplink on their respective assigned sets of pilot sub-bands, where the pilot sub-band sets can be interlaced.

Processors 1290 and 1250 direct (e.g., control, coordinate, manage, etc.) operation at access point 1205 and terminal 1230, respectively. Respective processors 1290 and 1250 can be associated with memory units (not shown) that store program codes and data. Processors 1290 and 1250 can also perform computations to derive frequency and time-based impulse response estimates for the uplink and downlink, respectively.

For a multiple-access system (e.g., SC-FDMA, FDMA, OFDMA, CDMA, TDMA, etc.), multiple terminals can transmit concurrently on the uplink. For such a system, the pilot sub-bands can be shared among different terminals. The channel estimation techniques can be used in cases where the pilot sub-bands for each terminal span the entire operating band (possibly except for the band edges). Such a pilot sub-band structure would be desirable to obtain frequency diversity for each terminal. The techniques described herein can be implemented by various means. For example, these techniques can be implemented in hardware, software, or a combination thereof. For a hardware implementation, which can be digital, analog, or both digital and analog, the processing units used for channel estimation can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes can be stored in memory unit and executed by the processors 1290 and 1250.

FIG. 13 illustrates a wireless communication system 1300 with multiple base stations (BSs) 1310 (e.g., wireless access points, wireless communication apparatus) and multiple terminals 1320 (e.g., ATs), such as can be utilized in conjunction with one or more aspects. A BS 1310 is generally a fixed station that communicates with the terminals and can also be called an access point, a Node B, or some other terminology. Each BS 1310 provides communication coverage for a particular geographic area or coverage area, illustrated as three geographic areas in FIG. 13, labeled 1302a, 1302b, and 1302c. The term “cell” can refer to a BS or its coverage area depending on the context in which the term is used. To improve system capacity, a BS geographic area/coverage area can be partitioned into multiple smaller areas (e.g., three smaller areas, according to cell 1302a in FIG. 13), 1304a, 1304b, and 1304c. Each smaller area (1304a, 1304b, 1304c) can be served by a respective base transceiver subsystem (BTS). The term “sector” can refer to a BTS or its coverage area depending on the context in which the term is used. For a sectorized cell, the BTSs for all sectors of that cell are typically co-located within the base station for the cell. The transmission techniques described herein can be used for a system with sectorized cells as well as a system with un-sectorized cells. For simplicity, in the subject description, unless specified otherwise, the term “base station” is used generically for a fixed station that serves a sector as well as a fixed station that serves a cell.

Terminals 1320 are typically dispersed throughout the system, and each terminal 1320 can be fixed or mobile. Terminals 1320 can also be called a mobile station, user equipment, a user device, wireless communication apparatus, an access terminal, a user terminal or some other terminology. A terminal 1320 can be a wireless device, a cellular phone, a personal digital assistant (PDA), a wireless modem card, and so on. Each terminal 1320 can communicate with zero, one, or multiple BSs 1310 on the downlink (e.g., FL) and uplink (e.g., RL) at any given moment. The downlink refers to the communication link from the base stations to the terminals, and the uplink refers to the communication link from the terminals to the base stations.

For a centralized architecture, a system controller 1330 couples to base stations 1310 and provides coordination and control for BSs 1310. For a distributed architecture, BSs 1310 can communicate with one another as needed (e.g., by way of a wired or wireless backhaul network communicatively coupling the BSs 1310). Data transmission on the forward link often occurs from one access point to one access terminal at or near the maximum data rate that can be supported by the forward link or the communication system. Additional channels of the forward link (e.g., control channel) can be transmitted from multiple access points to one access terminal. Reverse link data communication can occur from one access terminal to one or more access points.

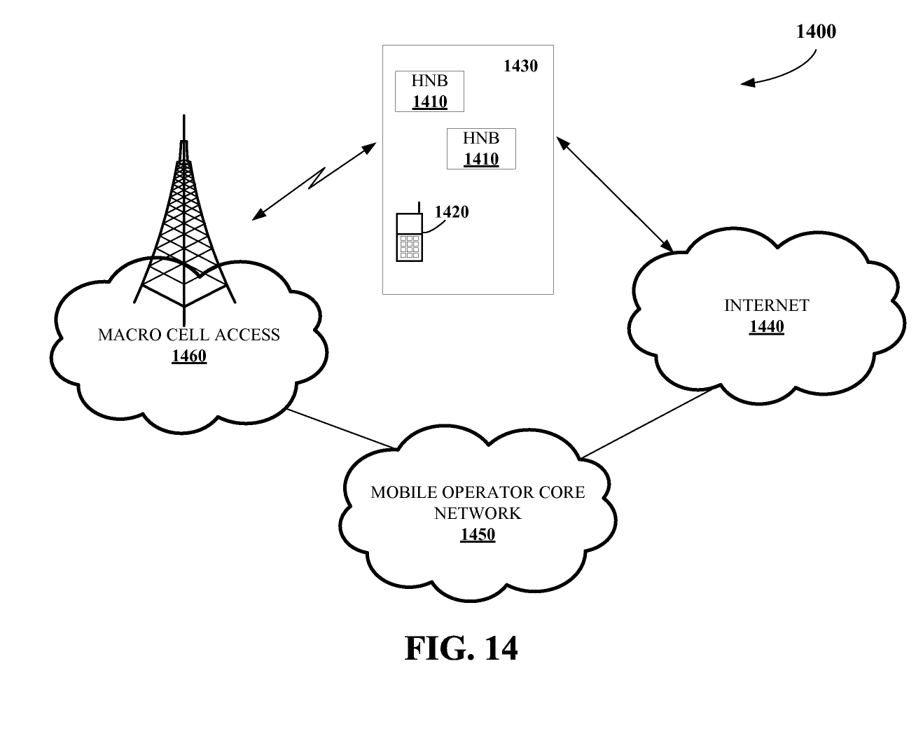

FIG. 14 illustrates an exemplary communication system 1400 to enable deployment of access point base stations within a network environment. As shown in FIG. 14, the system 1400 includes multiple access point base stations or Home Node B units (HNBs) or Femto cells, such as, for example, HNBs 1410, each being installed in a corresponding small scale network environment, such as, for example, in one or more user residences 1430, and being configured to serve associated, as well as alien, user equipment (UE) 1420. Each HNB 1410 is further coupled to the Internet 1440 and a mobile operator core network 1450 via a DSL router (not shown) or, alternatively, a cable modem (not shown) or another suitable Internet connection. Additionally, it should be appreciated that HNBs 1410 can exist within a macro cell access deployment 1460 to form a heterogeneous network comprising a planned deployment comprising macro cell access deployment 1460 and a semi-planned or unplanned deployment of HNBs 1410.

As used in the subject disclosure, the terms “component,” “system,” “module” and the like are intended to refer to a computer-related entity, either hardware, software, software in execution, firmware, middle ware, microcode, and/or any combination thereof. For example, a module can be, but is not limited to being, a process running on a processor, a processor, an object, an executable, a thread of execution, a program, a device, and/or a computer. One or more modules can reside within a process, or thread of execution; and a module can be localized on one electronic device, or distributed between two or more electronic devices. Further, these modules can execute from various computer-readable media having various data structures stored thereon. The modules can communicate by way of local or remote processes such as in accordance with a signal having one or more data packets (e.g., data from one component interacting with another component in a local system, distributed system, or across a network such as the Internet with other systems by way of the signal). Additionally, components or modules of systems described herein can be rearranged, or complemented by additional components/modules/systems in order to facilitate achieving the various aspects, goals, advantages, etc., described with regard thereto, and are not limited to the precise configurations set forth in a given figure, as will be appreciated by one skilled in the art.

Furthermore, various aspects are described herein in connection with a UE. A UE can also be called a system, a subscriber unit, a subscriber station, mobile station, mobile, mobile communication device, mobile device, remote station, remote terminal, access terminal (AT), user agent (UA), a user device, or user terminal (UT). A subscriber station can be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem or similar mechanism facilitating wireless communication with a processing device.

In one or more exemplary embodiments, the functions described can be implemented in hardware, software, firmware, middleware, microcode, or any suitable combination thereof. If implemented in software, the functions can be stored on or transmitted over as one or more instructions or code on a computer-readable medium. Computer-readable media includes both computer storage media and communication media including any medium that facilitates transfer of a computer program from one place to another. A storage media may be any physical media that can be accessed by a computer. By way of example, and not limitation, such computer storage media can comprise RAM, ROM, EEPROM, CD-ROM or other optical disk storage, magnetic disk storage or other magnetic storage devices, smart cards, and flash memory devices (e.g., card, stick, key drive . . . ), or any other medium that can be used to carry or store desired program code in the form of instructions or data structures and that can be accessed by a computer. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

For a hardware implementation, the processing units' various illustrative logics, logical blocks, modules, and circuits described in connection with the aspects disclosed herein can be implemented or performed within one or more ASICs, DSPs, DSPDs, PLDs, FPGAs, discrete gate or transistor logic, discrete hardware components, general purpose processors, controllers, micro-controllers, microprocessors, other electronic units designed to perform the functions described herein, or a combination thereof. A general-purpose processor can be a microprocessor, but, in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other suitable configuration. Additionally, at least one processor can comprise one or more modules operable to perform one or more of the steps and/or actions described herein.

Moreover, various aspects or features described herein can be implemented as a method, apparatus, or article of manufacture using standard programming and/or engineering techniques. Further, the steps and/or actions of a method or algorithm described in connection with the aspects disclosed herein can be embodied directly in hardware, in a software module executed by a processor, or in a combination of the two. Additionally, in some aspects, the steps or actions of a method or algorithm can reside as at least one or any combination or set of codes or instructions on a machine-readable medium, or computer-readable medium, which can be incorporated into a computer program product. The term “article of manufacture” as used herein is intended to encompass a computer program accessible from any suitable computer-readable device or media.

Additionally, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Furthermore, as used herein, the terms to “infer” or “inference” refer generally to the process of reasoning about or inferring states of the system, environment, or user from a set of observations as captured via events, or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events, or data. Such inference results in the construction of new events or actions from a set of observed events and/or stored event data, whether or not the events are correlated in close temporal proximity, and whether the events and data come from one or several event and data sources.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

What is claimed is:

1. A method for wireless communication, comprising:
employing a communication interface to obtain a data packet that is part of a wireless communication involving a mobile device;
employing a processor to analyze the data packet to determine a quality of service level (a QoS level) established for the data packet; and
employing the processor to mark the data packet with a different QoS level if the QoS level established for the data packet is incorrect.

2. The method of claim 1, wherein identifying whether the QoS level established for the data packet is incorrect further comprises analyzing reverse link traffic of the wireless communication.

3. The method of claim 2, further comprising determining whether the reverse link traffic requires an elevated QoS based at least in part on a type of the reverse link traffic and employing the elevated QoS for the different QoS level.

4. The method of claim 3, wherein determining whether the reverse link traffic requires the elevated QoS further comprises determining whether the type of the reverse link traffic is voice traffic or streaming media traffic.

5. The method of claim 3, further comprising generating a data table that correlates the type of the reverse link traffic to a reverse link QoS level specified by a data packet of the reverse link traffic.

6. The method of claim 5, further comprising identifying whether the QoS level established for the data packet is incorrect further comprises referencing the data table and comparing the data packet and the QoS level to the type of the reverse link traffic and the reverse link QoS level.

7. The method of claim 1, further comprising marking the data packet to a QoS level equivalent to that of reverse link QoS traffic of the wireless communication.

8. The method of claim 1, further comprising assigning the data packet to a security association (SA) of a broadband link that corresponds to the different QoS level.

9. The method of claim 1, wherein analyzing the data packet further comprises identifying an inner Internet Protocol header (an inner IP header) of the data packet and identifying a value of a differential services code point flag (a DSCP flag) specified by the inner IP header.

10. The method of claim 9, wherein determining the QoS level further comprises comparing the value of the DSCP flag to a predetermined QoS ranking.

11. The method of claim 9, further comprising generating an outer IP header for the data packet and marking the outer IP header with a DSCP value that corresponds with the different QoS level.

12. An apparatus for wireless communication, comprising:
a communication interface that electronically communicates with a broadband link and with a wireless link, wherein the communication interface obtains downlink traffic (DL traffic) from the broadband link and obtains uplink traffic (UL traffic) from the wireless link;
memory for storing instructions configured to establish quality of service (QoS) policies for the DL traffic or the UL traffic; and
a data processor for executing modules that implement the instructions, the modules comprising:
an analysis module that identifies a set of UL traffic and a set of DL traffic pertaining to a communication stream;
an inspection module that identifies a QoS level associated with a data packet of the communication stream;
a marking module that updates the QoS level if the QoS level is inconsistent with a reverse direction QoS level of a reverse direction data packet of the communication stream routed in an opposite direction as the data packet.

13. The apparatus of claim 12, wherein the data packet is an UL data packet obtained from a user equipment (a UE) over the wireless link, and the reverse direction data packet is a DL data packet obtained from a Femto gateway (FGW) over the broadband link.

14. The apparatus of claim 12, wherein the data packet is a DL data packet obtained from a FGW over the broadband link, and the reverse direction data packet is an UL data packet obtained from a UE over the wireless link.

15. The apparatus of claim 12, wherein the QoS level is a default level for best effort traffic or an elevated level for high priority traffic.

16. The apparatus of claim 15, wherein the high priority traffic comprises voice traffic or streaming video or streaming audio traffic.

17. The apparatus of claim 12, wherein the marking module changes the QoS level to the reverse direction QoS level if the reverse direction QoS level is different from the QoS level.

18. The apparatus of claim 12, further comprising a reference module that generates a data table stored in the memory that correlates a type of traffic associated with the communication stream with the reverse direction QoS level.

19. The apparatus of claim 18, wherein the marking module references the data table to determine whether to update a second QoS level of data packets of a second communication stream based on whether the second communication stream carries the type of traffic.

20. The apparatus of claim 12, further comprising a security module that establishes a priority and a security association for the data packet that matches an updated QoS level of the data packet established by the marking module.

21. The apparatus of claim 12, wherein the marking module updates the QoS level of the data packet by encapsulating the data packet in an IP header that includes an updated QoS level.

22. The apparatus of claim 21, wherein the updated QoS level is specified as a value of a differential services code point flag within the IP header.

23. An apparatus for wireless communication, comprising:
means for employing a communication interface to obtain a data packet from a mobile device over a wireless link;
means for employing a processor to analyze the data packet to determine a quality of service level (a QoS level) established for the data packet; and
means for employing the processor to mark the data packet with a reverse link QoS level of a reverse link data packet if the QoS level established for the data packet is different from the reverse link QoS level.

24. At least one processor configured for wireless communication, comprising:
a module that obtains a data packet from a mobile device over a wireless link;
a module that analyzes the data packet to determine a quality of service level (a QoS level) established for the data packet; and
a module that marks the data packet with a reverse link QoS level of a reverse link data packet if the QoS level established for the data packet is different from the reverse link QoS level.

25. A computer program product, comprising:
a computer-readable medium, comprising:
code for causing a computer to obtain a data packet from a mobile device over a wireless link;
code for causing the computer to analyze the data packet to determine a quality of service level (a QoS level) established for the data packet; and
code for causing the computer to mark the data packet with a reverse link QoS level of a reverse link data packet if the QoS level established for the data packet is different from the reverse link QoS level.

26. A method of wireless communication, comprising:
employing a communication interface for electronic communication with a Femto access point (a FAP) via a broadband link and with an Internet Protocol gateway (an IP gateway) over an IP network link;
employing a data processor to analyze a quality of service level (a QoS level) of a data packet of a communication stream received at the communication interface; and
employing the data processor to update the QoS level if the QoS level is inconsistent with reverse link traffic of the communication stream.

27. The method of claim 26, further comprising determining the QoS level from an IP header of the data packet.

28. The method of claim 27, wherein the QoS level is specified as part of a user datagram protocol flag (a UDP flag) of the IP header.

29. The method of claim 27, wherein the QoS level is specified as part of a differential code services point flag (a DSCP flag) of the IP header.

30. The method of claim 26, further comprising receiving the data packet as part of a downlink (DL) stream of the communication stream from the IP gateway, and receiving reverse link traffic as part of an uplink (UL) stream of the communication stream over the broadband link from the FAP.

31. The method of claim 26, further comprising receiving the data packet as part of an UL stream of the communication stream from the FAP over the broadband link, and receiving the reverse link traffic as part of a DL stream of the communication stream from the IP gateway.

32. The method of claim 26, wherein updating the QoS level further comprises wrapping the data packet in an outer IP header and marking the outer IP header with an updated QoS level.

33. The method of claim 32, wherein the updated QoS level is an equivalent QoS level as a reverse link QoS specified by the reverse link traffic.

34. The method of claim 26, wherein updating the QoS level further comprises changing the QoS level specified for the data packet to a reverse link QoS value specified by the reverse link traffic.

35. The method of claim 26, further comprising building a dataset of reverse link QoS as a function of type of traffic for a plurality of communication streams.

36. The method of claim 35, further comprising determining a reverse link QoS of the reverse link traffic at least in part from the dataset.

37. An apparatus for wireless communication, comprising:
a communication interface that communicatively couples the apparatus to an Internet Protocol gateway (an IP gateway) via an IP link, and to a Femto access point (a FAP) via a broadband Internet link;
memory for storing instructions configured to establish appropriate quality of service (QoS) for a data packet of a communication stream; and
a data processor for executing modules that implement the instructions, the modules comprising:
an analysis module that determines a current QoS specified for the data packet;
an arbitration module that modifies the current QoS if a reverse direction QoS specified in a data packet of the communication stream that is routed in an opposite direction as the data packet is different from the current QoS.

38. The apparatus of claim 37, further comprising an inspection module that analyzes traffic contained within the data packet and determines a type of the traffic.

39. The apparatus of claim 38, wherein the inspection module determines the type of the traffic to be voice traffic, streaming media traffic, or browsing traffic.

40. The apparatus of claim 37, wherein the arbitration module modifies the current QoS to a specific QoS suitable for voice traffic if the reverse direction QoS is the specific QoS suitable for voice traffic.

41. The apparatus of claim 37, wherein the arbitration modules modifies the current QoS to a specific QoS suitable for streaming media traffic if the reverse direction QoS is the specific QoS suitable for streaming media traffic.

42. The apparatus of claim 37, wherein the arbitration module modifies the current QoS to a best effort QoS suitable for browsing traffic if the reverse direction QoS is the best effort QoS.

43. The apparatus of claim 37, further comprising a security module that transmits the data packet over the broadband Internet link with a security association correlated to the current QoS, or correlated to a modified QoS if the arbitration module modifies the current QoS.

44. The apparatus of claim 43, wherein the security module gives the data packet a priority correlated to the current QoS, or correlated to the modified QoS if the arbitration module modifies the current QoS.

45. The apparatus of claim 43, wherein the security association is further correlated to a protocol type of the data packet, and further wherein the protocol type is a generic routing encapsulation, a user datagram protocol, or a transport control protocol.

46. The apparatus of claim 37, wherein the data packet is a downlink data packet received from the IP gateway, and the data packet routed in the opposite direction is uplink traffic transmitted by the FAP over the broadband Internet link.

47. The apparatus of claim 37, wherein the data packet is an uplink data packet received from the FAP over the broadband Internet link, and the data packet routed in the opposite direction is downlink traffic transmitted by the IP gateway.

48. An apparatus for wireless communication, comprising:
means for employing a communication interface for electronic communication with a Femto access point over a broadband link and with an Internet Protocol (IP) gateway over an IP network link;
means for employing a data processor to analyze a quality of service level (a QoS level) of a data packet of a communication stream received at the communication interface; and
means for employing the data processor to update the QoS level if the QoS level is inconsistent with reverse link traffic of the communication stream.

49. At least one data processor configured for wireless communication, comprising:
a module for electronic communication with a Femto access point (a FAP) over a broadband link and with an Internet Protocol gateway (an IP gateway) over an IP network link;
a module that analyzes a quality of service level (a QoS level) of a data packet of a communication stream received from the FAP or the IP gateway; and
a module that updates the QoS level if the QoS level is inconsistent with reverse link traffic of the communication stream.

50. A computer program product, comprising:
a computer-readable medium, comprising:
code for causing a computer to exchange electronic communication with a Femto access point (a FAP) over a broadband link and with an Internet Protocol gateway (an IP gateway) over an IP network link;
code for causing the computer to analyze a quality of service level (a QoS level) of a data packet of a communication stream received from the FAP or the IP gateway; and
code for causing the computer to update the QoS level if the QoS level is inconsistent with reverse link traffic of the communication stream.
